(19) United States
(12) Patent Application Publication
(10) Pub. No.: US 2015/0206221 A1
(43) Pub. Date: Jul. 23, 2015

(54) SERVICE-ORIENTED ACCESS TO MEDIA CONTENT

(71) Applicant: iDisciple, LLC, Alpharetta, GA (US)

(72) Inventors: Michael Clifton Kendrick, Alpharetta, GA (US); Richard Lee Jackson, Alpharetta, GA (US); Hal Maurice White, Alpharetta, GA (US)

(73) Assignee: iDisciple, LLC, Alpharetta, GA (US)

(21) Appl. No.: 14/159,862

(22) Filed: Jan. 21, 2014

(51) Int. Cl. G06Q 30/06

(52) U.S. Cl. CPC G06Q 30/0631

(57) ABSTRACT

Disclosed are various embodiments for receiving input that provides user characteristics for a user, where the user characteristics are to be associated with a user account. Curated content is identified, based on the user characteristics, from content provided by multiple distribution partners. The curated content is delivered in a feed to a client device. A panel is provided, within a user interface of the client device, that integrates an option for accessing the feed of the curated content and an option for accessing an additional faith-based service.

### BACKGROUND

Identifying new media items likely to be enjoyed by a user may be difficult. Users typically resort to performing searches for media items based upon an incomplete set of search criteria.

### SUMMARY OF THE INVENTION

The disclosed embodiments relate to a system, computer-readable medium, and methods for delivering, through a user-interface, a “feed” of curated media content provided by distribution partners. In some embodiments, a portal service executed by a server device obtains input providing user characteristics for a user to be associated with a user account. The portal service may identify, based on the user characteristics, curated media content from media content provided by multiple distribution partners. The phrase “curated content” or “curated media content” refers to any content that is customized or otherwise selected based on one or more user's particular characteristics. The curated content may be delivered in a feed within a user interface to a client device. The user interface may include a panel integrating an option for accessing the feed of the curated content and an option for accessing an additional faith-based service. The curated content present in the feed may be modified based upon a rating of the curated content by the user.

The phrase “faith based service” refers to any feature provided via a computing device that provides a function that is particularly associated with and targeted to a religious, cultural, or personal belief, faith, or community. Exemplary additional faith-based services may include one or more of: an archive of faith-related feed information, a library of faith-related multimedia items previously selected by the user, a plurality of multimedia channels at least some of which are faith-related and that are available to the user, a charitable giving account, and additional faith-related multimedia items available for purchase by a user. One or more of the additional faith-based services may be available to users who have paid a subscription fee. In other embodiments, a donation may be generated to the charitable giving account of a user based upon a referral of one or more people by the user. The referral may be based upon a referral message sent by the user to one or more of the people, or one or more of the people dereferencing a uniform resource identifier (URI) associated with the user.

In various embodiments, input providing user characteristics may be received for a user, where the user characteristics may be associated with a user account. Curated media content may be identified, based on the user characteristics, from content provided by multiple distribution partners. The curated content may be delivered in a feed to a client device capable of accessing data via a network interface. The curated content is provided within an application interface based on being signed into the user account. A panel is provided that may integrate an option for accessing the feed of the curated content and an option for accessing an additional faith-based service. The additional faith-based service may be a charitable giving account. The charitable giving account may be associated with a recipient charity selected by the user from among a plurality of available charities. The additional faith-based service may also include: an archive of the feed, a library of multimedia items previously selected by the user, a plurality of multimedia channels available to the user, and/or additional multimedia items available for consumption by the user.

In some embodiments, a donation may be made to the charitable giving account of the user based upon a referral of a first person by the user. An amount of the donation to the charitable giving account of the user is based upon a subscription fee collected from the first person. The donation to the charitable giving account of the user may also be based upon a referral of a second person by the first person. The amount of the donation being also being based upon a subscription fee collected from the second person. A donation may also be made to a charitable giving account of the first person based upon a referral of the second person by the first person.

In still other embodiments, a program may include code to obtain input providing user characteristics for a user, where the user characteristics are to be associated with a user account. Curated content may be identified, based on user characteristics, from content provided by multiple distribution partners. The curated content may be delivered in a feed to a client device. The curated content may be encoded within a user interface based on the user being signed into the user account. A panel may be provided that integrates an option for accessing the feed of the curated content and an option for accessing an additional faith-based service. In some embodiments, the additional faith-based service may include: an archive of the feed, a library of multimedia items previously selected by the user, a plurality of multimedia channels available to the user, a charitable giving account, and/or additional multimedia items available for purchase by the user.

In other embodiments, the additional faith-based service includes additional multimedia content available when the user is a paid subscriber. The additional multimedia content may be available to a non-subscriber when the user shares the additional multimedia content with the non-subscriber, the user being the paid subscriber.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of networked environment according to various embodiments of the present disclosure.

FIG. 2 is a drawing of an example user interfaces rendered by a client in the networked environment of FIG. 1 according to various embodiments of the present disclosure.

FIG. 3 is a drawing of an example user interfaces rendered by a client in the networked environment of FIG. 1 according to various embodiments of the present disclosure.

FIG. 4 is a drawing of an example user interfaces rendered by a client in the networked environment of FIG. 1 according to various embodiments of the present disclosure.

FIG. 5 is a flowchart illustrating an example of functionality implemented as portions of a recommendation engine executed in a computing device in the networked environment of FIG. 1 according to various embodiments of the present disclosure.

FIG. 6 is a schematic block diagram that provides one example illustration of a computing device employed in the networked environment of FIG. 1 according to various embodiments of the present disclosure.

### DETAILED DESCRIPTION

In the following discussion, a general description of the system and its components are provided, followed by a discussion of the operation of the same.

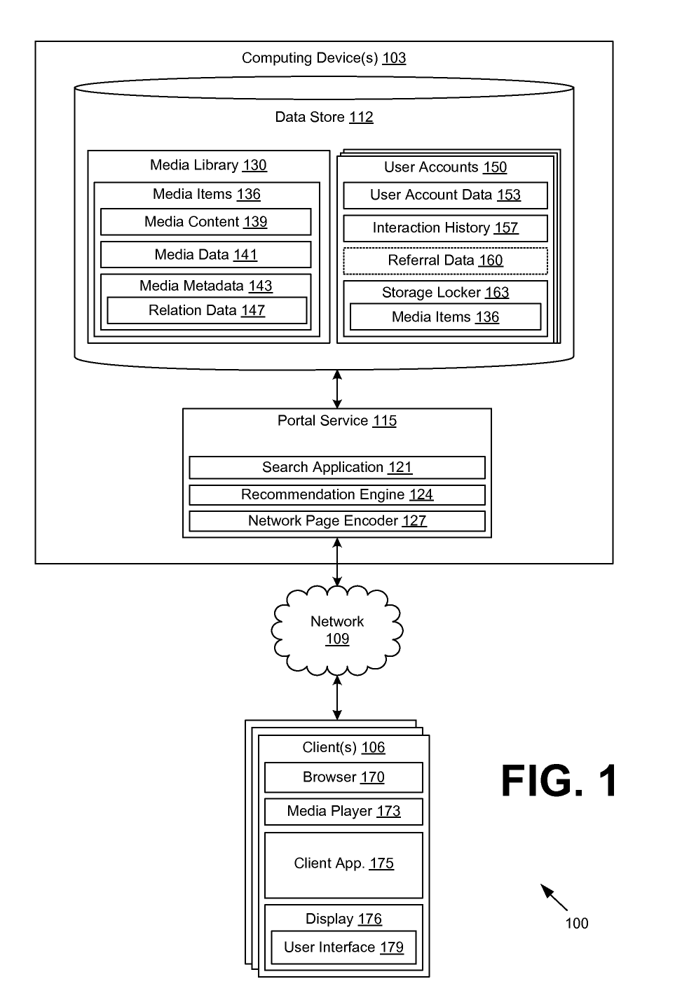

With reference to FIG. 1, shown is a networked environment 100 according to various embodiments. The networked environment 100 includes a computing device 103, clients 106, and a network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

Various applications and/or other functionality may be executed in the computing device 103 according to various embodiments. Also, various data is stored in a data store 112 that is accessible to the computing device 103. The data store 112 may be representative of a plurality of data stores as can be appreciated. The data stored in the data store 112, for example, is associated with the operation of the various applications and/or functional entities described below.

The components executed on the computing device 103, for example, include a portal service 115 and other applications, services, processes, systems, engines, or functionality not discussed in detail herein. The portal service 115 may include various components, such as a media search application 121, a recommendation engine 124, a network page encoder 127, and other applications and/or processes.

The portal service 115 is executed in order to facilitate the online delivery of media items over the network 109. The portal service 115 also performs various back-end functions associated with the online presence of a merchant in order to facilitate the online purchase of media items. To support these operations, the portal service 115 may include a commercially available hypertext transfer protocol (HTTP) server such as, for example, Apache® HTTP Server, Apache® Tomcat®, Microsoft Internet Information Services (IIS), etc. For example, the portal service 115 may generate various network pages, using the network page encoder 127, such as web pages, or other types of network content that are provided to clients 106 for the purposes of presenting media items for purchase, rental, download, lease, or any other forms of consumption as can be appreciated. In various embodiments, the network pages encoded by the portal service 115 may include code that functions as an embedded audio player, video player, image viewer, etc. in order for the user to consume the media items. In other embodiments, a mobile application may be executed in a client 106 to generate and render user interfaces using data served up by the computing device 103 and/or other servers. To this end, when rendered, network pages generate a user interface on the client 106 as can be appreciated.

The media search application 121 may be executed to search data available to the computing device 103 and to encode, for rendering by the client 106, one or more search result network pages in response to a search query. Lastly, the recommendation engine 124 is executed to generate one or more media item recommendations to present to the user based upon media preference data associated with the user.

The data stored in the data store 112 includes, for example, a media library 130 of media items 136, user accounts 150, and potentially other data. Associated with each of the media items 136 is media content 139, media data 141, media metadata 143, and potentially other data. The media content 139 comprises, for example, audio content, video content, image content, textual content, electronic book content, and/or content associated with each of the media items 136 in the media library 130. In some embodiments, portions of the media items 136 and/or media content 139 may be provided by one or more other business entities that may collectively be referred to as “distribution partners.” The media data 141 comprises information about each of the media items 136, such as, for example, customer reviews, customer ratings, statistics generated from server log data that indicate the number of downloads or previews (e.g., only the first minute of the media item was played out) associated with each of the media items 136, and potentially other data. The media metadata 143 includes relation data 147 comprising identifiers for other media items 136 associated with a given media item 136 (e.g. a movie may be associated with a soundtrack to the movie and the book upon which the movie is based). The media metadata 143 may further comprise other data useful in searching media items 136, such as, for example, media titles, artist titles, media images, genre titles, album titles, media descriptions, media types (e.g. video, audio, etc.), media prices, media subject categories, and potentially other data.

Associated with each user account 150 may be, for example, user account data 153, an interaction history 157, a referral data 160, a storage locker 163, and potentially other data. The user account data 153 may include information about the user and their user account 150, such as, for example, name, address, payment instruments, billing information, account settings, passwords, security credentials, user group membership, subscriptions, file management permissions, storage quotas and limitations, profile or demographic data associated with users, and/or other data.

The interaction history 157 may include user-specific data related to a history of browsing and/or purchasing of media items 136 through the portal service 115, a history of searches for media items 136 through the portal service 115, a history of media items 136 accessed, a history of media items 136 stored in the storage locker 163, reviews of media items 136 made by the user, and/or other possible data. The referral data 160 may include the referrals made by a user to other users as well as to other people who may not currently be registered with a user account 150. The referrals may include uniform resource identifiers (URIs) for the referred media items 136, contact information for a referred person, identifiers for any user account 150 associated with the referred person, and/or potentially other data. Each user account 150 also comprises a storage locker 163 for the user to store one or more media items 136 either possessed by the user or purchased from the portal service 115 as will be described. Throughout this disclosure, the interaction history 157, the contents of the storage locker 163, the media data 141 from a given user, and potentially other data sources may collectively be referred to as media preference data.

The client 106 is representative of a plurality of client devices that may be coupled to the network 109. The client 106 may comprise, for example, a processor-based system such as a computer system. Such a computer system may be embodied in the form of a desktop computer, a laptop computer, a personal digital assistant, a cellular telephone, a smartphone, a set-top box, a music player, a web pad, a tablet computer system, a game console, an electronic book reader, or other devices with like capability.

The client 106 may be configured to execute various applications such as a browser 170, a media player 173, a client application 175 and/or other applications. The browser 170 may be executed in a client 106, for example, to access and render network pages, such as web pages, or other network content served up by the computing device 103 and/or other servers. When executed in a client 106, the browser 170 renders network pages on a user interface 179 of a respective display 176 and may perform other functions. The browser 170 accesses network pages, such as web pages or other types of content from the computing device 103 in order to access the functionality of the search application 121, the recommendation application 124, and other components implemented in the computing device 103 as will be described.

Alternatively, a client application 175 may be executed in a client 106 to generate and render user interfaces 179 using data served up by the computing device 103 and/or other servers. To this end, when rendered, network pages generate a user interface 179 as can be appreciated. During execution, the client application 175 may use various sensor services such as, for example, a geographic location (“geolocation”) service and/or sensor services as can be appreciated. The geolocation service may use global positioning system (GPS) receivers, cell network positioning, Wi-Fi™ positioning, near field communications (NFC), and/or other technologies as can be appreciated.

The media player 173 is executed to play out media items 136 obtained through the computing device 103, the client 106, or elsewhere. The media player 173 may be a stand-alone application, a plug-in for the browser 170 and/or client application 175, or other code included within a network page served up by the network page encoder 127. The client 106 may be configured to execute applications beyond the browser 170, the media player 173, and the client application 175, such as, for example, email applications, instant message applications, and/or other applications.

Next, a general description of the operation of the various components of the networked environment 100 is provided. To begin, a client 106 may establish communication, via the network 109, with the computing device 103 using hypertext transfer protocol (HTTP), HTTP secure (HTTPS), remote procedure call (RPC), user datagram protocol (UDP), transmission control protocol (TCP), Internet protocol (IP), and/or other network protocols as can be appreciated. In the event the operator of the client 106 has previously established a user account 150 on the computing device 103, the client 106 may provide credentials with which to authenticate with the user account 150.

In the event the operator of the client 106 has not previously created a user account 150, the operator may interact with the portal service 115 to create a user account 150. In some embodiments, different types of user accounts 150 may be created, such as, for example, a no-cost account with limited functionality, an advertisement-supported account offering additional functionality, a paid subscription account offering extended functionality, an administrator account for managing groups of user accounts 150, and/or other types of user accounts as may be appreciated. A new user may be prompted to complete a profile that may include supplying personal information (e.g. age, income, location of residence, occupation, religious affiliation, length of affiliation, etc.) and/or preferences for various types of media items 136.

Alternatively, the client 106 may be provided with access to a portion of the media items 136 without being associated with a user account 150 (i.e. a “guest user”). In some embodiments, guest users may be asked for similar information as a new user, such as a profile that may include supplying personal information (e.g. age, income, location of residence, occupation, religious affiliation, length of affiliation, etc.) and/or preferences for various types of media items 136. In other embodiments, guest users may instead be initially assigned default media preference data.

Upon establishing a communication session between the client device 106 and the computing device 103, the recommendation engine 124 may employ any available media preference data in order to determine media items 136 for the communication session. In addition, the recommendation engine 124 may further limit some or all of the media items 136 recommended to the portion of the media items 136 that are authorized for the current communication session. The media items authorized for the communication session may be based on the user account data 153 or the default authority given to a guest user.

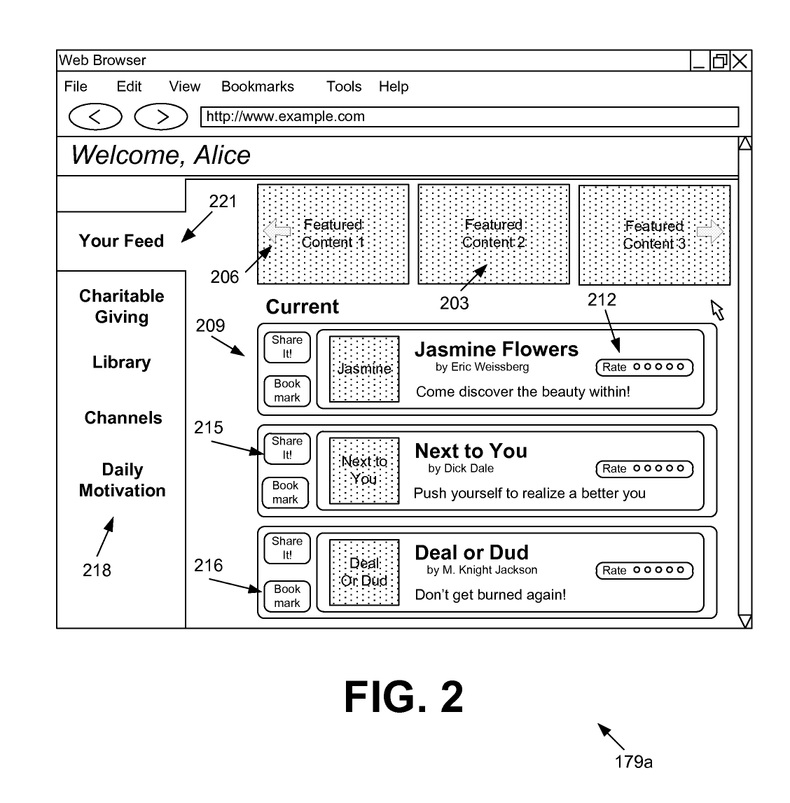

Thereafter, upon obtaining available sources of media preference data, the recommendation engine 124 may provide recommended media items 136 to the network page encoder 127, where the recommended media items 136 are based upon the available media preference data. This portion of the execution of the recommendation engine 124 may be initiated based upon changes to the media presence data, a request by the user, a periodic schedule, and/or upon occurrence of other events. The recommended media items 136 may be specified by a network page encoded for presentation as a user interface 179 on the client 106 as will be described further in relation to FIGS. 2-4. As discussed previously, the user interface 179 generated from the network page may be presented by the client application 175, the browser 170, and/or other possible application.

The user interface 179 may include a “feed” in which one or more of the recommended media items 136 are suggested to the user. In some embodiments, the feed may be structured based upon rules for the type of media items 136 available. For example, the first item presented in the feed may be a promotion for a soon-to-be-released recommended media item 136, the second item presented in the feed may be an excerpt from a particular recommended book or document, and the remaining items in the feed may be recommended media items 136 that may be selected based on default or user-defined media metadata (e.g. music, video presentations, electronic books, etc.).

The media items 136 available through the user interface 179 may further include “channels.” The channels may be produced periodically by various content providers, and each of the channels may offer consistent thematic programming. Users may select the channels of interest to them, and may be presented with content for the channels as it is made available. For example, one channel may include weekly presentations by a well-known speaker such that new content (i.e. the weekly presentation) is available for the channel each week. In some embodiments, content from previous “episodes” of the channel may also be available for review. Furthermore, channels or other types of media items 136 may be restricted on the basis of the type of user account 150 associated with the user. For example, all channels may be available to any registered user, but not guest users. As an alternative example, user accounts 150 associated with a paid subscription may have access to all channels, whereas unpaid user accounts 150 may access only a subset of the available channels. In addition, access to selected channels may be available for purchase.

The user interface 179 may also provide access to “premium content” that includes media items 136 the may be acquired for an additional payment. In some embodiments, the premium content may be purchased and stored in the storage locker 163 for the user. In other embodiments, access acquired to the premium content may be limited based upon a period of time, a number of accesses of the premium content, the client 106 used to access the premium content, and/or other possible limitations as can be appreciated. In addition, the user interface 179 may offer a “library” where a user may conveniently access media items 136 in his/her storage locker 163, media items 136 that have been bookmarked, acquired premium content, media items 136 that have been shared with the user by others, and/or other possible data.

The user interface 179 may also offer the ability to search media items 136. In some embodiments, the media items 136 search may be filtered by content that is available to the particular user (i.e. hide unavailable media items 136), content type (e.g. images, news, e-books, audio, video, etc.), by content source (e.g. feed, user library, channels, premium content, etc.), and/or by other criteria as can be appreciated. Unless filtered, a portion of the media items 136 identified through the search may not be available to the current user because the media item(s) 136 are identified as premium-content, the user authorization in the user account data 153 or as a guest user, and/or based on other conditions as can be appreciated.

While some media items 136 may be limited to a particular user account 150 or types of user accounts 150, in some embodiments, a user who is authorized to access a media item 136 may choose to “share” the particular media item 136 with another user. The share may be distributed using a uniform resource identifier (URI) that may uniquely identify the media items 136 being shared and the user account 150 granting the share, if the grantor is not a guest user. By sharing the media item 136, the authorized user grants access to the media item 136 to the other user without requiring the other user to previously have had access to it. Restrictions may apply to the sharing capability, such as, for example, granting access to the other user for a limited period of time/accesses, not permitting sharing a certain media items 136, limiting the number of media items 136 that may be shared by or shared with a particular user, and/or other possible limitations as can be appreciated.

In some embodiments, notice of the share may be a message composed and transmitted to defined recipients via email, simple message service/multimedia message service (SMS/MMS), an instant message (IM) service, and/or through other forms of electronic messaging as can be appreciated. In other embodiments, creation of the share may simply provide the granting user with the URI with which a recipient may access the share. Thereafter, the user may distribute the URI to one or more recipients using any means of distribution that may be desired.

Creation and/or distribution of the share may be recorded in the referral data 160. In some embodiments, the granting user account 150 may receive a referral bonus for sharing media items 136, distributing the share to recipients, having recipients access the shared media item 136, having recipients register for a user account 150 and/or for a paid subscription, and/or for other possible actions as can be appreciated. In various embodiments, referred users may refer media items 136 to others. In these embodiments, a referral bonus may be generated not only for the user who generated a particular referral, but also for the one or more “ancestral users” who previously created the referral(s) that ultimately led to the user being contacted.

The referral bonus for a user may be stored as a value in a referral account associated with the user account 150. In various embodiments, all or a portion of the value in the referral account may be paid to a charitable organization selected by the user, in which case the referral account may be referenced as a “charitable giving account,” “donation account,” etc. The user interface 179 may provide the ability to search available charitable organizations, select one or more charitable organization to receive a donation, the amount or allocation of the donations, etc. For example, Alice shares a video with Bob who accesses the video and decides to sign-up for a user account 150 with a paid subscription. As a result, Alice receives in her account a referral bonus of 20%, for example, of the subscription price paid for by Bob. Thereafter, Bob shares a news article with Charles who accesses the article and also decides to sign-up for a user account 150 with a paid subscription. In this example, Bob receives in his account a referral bonus of 20% of the subscription price paid for by Charles, and Alice may receive a referral bonus of 10%, for example, since she was the “ancestral user” who referred Bob. Furthermore, in some embodiments, the bonus may be given for ongoing subscription payments (e.g. monthly payments), not only the initial subscription price.

While the user interacts with the user interface 179 sharing, bookmarking, and accessing the media items 136, the portal service 115 may collect the interaction history 157 associated with the interactions. For example, the interaction history 157 may capture a rating given by the user of a media item 136. As another example, the interaction history 157 may capture the fact that a user routinely reads e-books and an advice column produced by a particular writer. Additionally, the interaction history 157 may also capture the fact that the user has twice paid to purchase and listen to albums by a particular music artist through the user interface 179. The collected interaction history 157 may be used to improve the recommendations made for the user by the recommendation engine 124.

In some embodiments, the recommendation engine 124 may correlate the “foundational” media items 136 identified within the various sources of media preference data with related media items 136 defined in the relation data 147. The related media items 136 may be in a different format type than the foundational media items 136 which serve as the basis for the recommendation. For example, the interaction history 157 for a user may indicate a purchase of a particular movie. Based upon this foundational media item 136 for the movie, the relation data 147 may indicate that a related media item 136 is an electronic book on which the movie is based, as well as potentially many other media items 136 of varying relation to the foundational media item 136 (e.g. other works by an author, other movies based on books by the author, etc.).

In other embodiments, the recommendation engine 124 may provide a recommendation to a user for the same media item 136 included within the preference data. Such a recommendation may be appropriate when the recommendation is based upon a limited access to a media item 136 (e.g. video rental, subscription-based access, etc.), when the user has previously sampled the media item 136, and/or other possible scenarios.

Referring next to FIG. 2, shown is an illustrative example of a user interface 179 (FIG. 1), denoted herein as user interface 179a encoded by the portal service 115 (FIG. 1) and rendered by a browser 170 (FIG. 1) executed by a client 106 (FIG. 1). Within the user interface 179a of FIG. 2, a feature panel 203 may be included from which promotional media items 136 may be presented to a user. Each item presented in the feed may provide a link to a respective media item 136 and/or additional metadata associated with the respective media item 136. The links of the items in the feed may be dereferenced after receiving an appropriate indication from an input method, such as a click of a mouse. It is understood, however, that an indication from an input method may be entered in a variety of ways such as, for example, by clicking on a link, by depressing a key on a keyboard, a touch on a touchscreen, and/or by other methods.

The feature panel 203 may be structured based upon rules for the type of promotional media items 136 available. For example, the first item presented in the feature panel 203 may be a promotion for a soon-to-be-released media item 136, the second item presented may be an excerpt from a particular promotional book or document, and the remaining items in the feature panel 203 may be recommended media items 136 that may be selected based on default or user-defined media metadata (e.g. music, video presentations, electronic books, etc.). In addition, the feature panel 203 may be extended by a scroll to display additional media items 136. A user may navigate the scroll of the feature panel 203 through use of navigation devices 206 such as scroll bars, directional arrows, etc.

The user interface 179a may further include a feed 209 made up of one or more recommended media items 136 generated by the recommendation engine 124. As described previously, the recommended media items 136 in the feed may be based upon the various media preference data associated with the user, and the listings in the feed 209 may contain basic information about the representative media item 136, such as name, artist/author, artwork, etc. In addition, items in the feed 209 may have a rating area 212 where users can indicate their opinion of the media item 136 represented in the feed. The rating given in the rating area 212 may be captured in the interaction history 157 as feedback for the recommendation engine 124. Additionally, the rating may also be captured in the media data 141 where it may be used in calculating a generalized rating of the media item 136 across multiple user reviewers.

The user interface 179a may also include a share region 215 allowing the user to share the media item 136 with others, which may include other users, as well as others who are not users. In some embodiments, after applying the appropriate input indication to the share region 215, the user may be prompted to provide contact information (e.g. email address, username, mobile number, etc.) for the others with whome the media item 136 should be shared. In other embodiments, the user may simply be provided with a URI representing the shared media item 136. In these embodiments, the user may distribute the URI to others through various possible means as may be desired by the user. In addition, the user interface 179a may include a bookmark region 216 that allows an identifier for the bookmarked media items 136 in the feed 209 to be stored for later reference by the user.

The control panel region 218 of the illustrative user interface 179a provides a brief listing of the various areas of the user interface 179a available to the user, as well as simple navigation to reach those areas by applying the appropriate input indication. The control panel 218 may further include an area indicator 221 providing a visual indication of the present area of the control panel 218 through which the user is presently navigating.

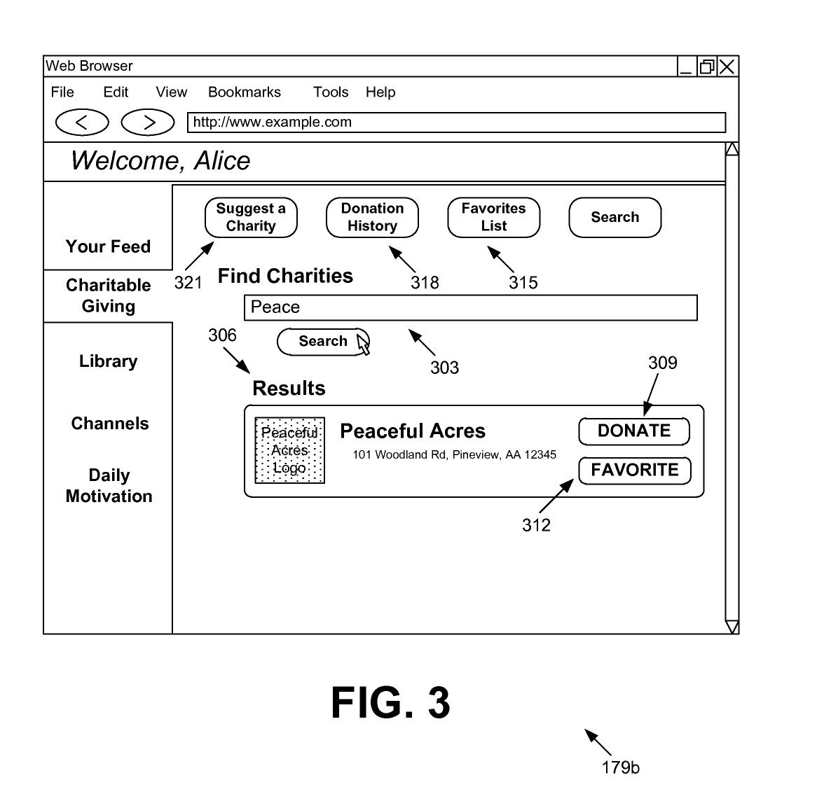

Moving on to FIG. 3, shown is an illustrative example of a user interface 179 (FIG. 1), denoted herein as user interface 179b generated by the portal service 115 (FIG. 1) and rendered by a browser 170 (FIG. 1) executed by a client 106 (FIG. 1). The user interface 179b may be generated as a result of a search performed of charitable organizations.

Within the user interface 179b of FIG. 3, a search field 303 may be included from which a user may specify the terms to be used to search for charitable organizations available to be recipients of donations from a referral account. The results of the search of charitable organizations may be presented in the results pane 306. Each of the results may include basic information about the charity such as name, address, logo, etc., and the results may also include hyperlinks to a website for the charity or to further information about the charity.

The results listed in the results pane 306 may also include a donate region 309 that is responsive to an input received from an input device (e.g. a mouse click). When activated, the donate region 309 may prompt the user to specify an amount or percentage of the referral account balance of the user to be donated to the respective charity. In addition, a favorite region 312 may be responsive to an input received from an input device such that, when activated, it records a charity as a favorite for the user from among the available charities. Charities that are included in the list of favorites for a user may be reviewed by activating the favorites list region 315 by providing input from an input device. Similarly, previous donations made by a user may be reviewed by activating the donation history region 318 by providing input from an input device. In addition, the user interface 179b may include a charity suggestion region 321 that, when activated, allows the user to submit a charity for possible inclusion in the list of available charities that are eligible for donations from referral accounts.

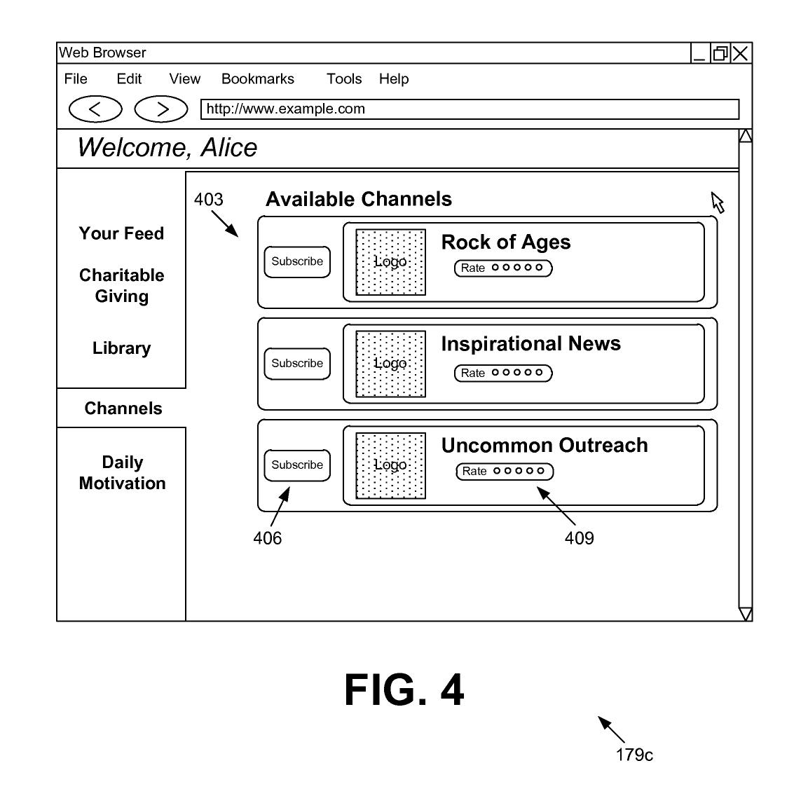

Turning now to FIG. 4, shown is an illustrative example of a user interface 179 (FIG. 1), denoted herein as user interface 179c generated by the portal service 115 (FIG. 1) and rendered by a browser 170 (FIG. 1) executed by a client 106 (FIG. 1). The user interface 179c may be generated as a result of a user selecting the “Channels” area within the control panel region of the user interface 179.

Within the user interface 179c of FIG. 4, a list of available channels may be presented to the user in the available channels region 403. In some embodiments, the channels presented in the available channels region 403 may be a list of recommended channels generated by the recommendation engine 124 rather than a complete channel listing. In other embodiments, a search field may be present that permits the user to search for a desired channel using various criteria such as name, channel provider, subject, and/or other criteria as can be appreciated. Each of the channel listings in the channels region 403 may include a subscription region that, when activated by receiving input from an input device, subscribes the user account 150 of the user to the respective channel. In addition, the channel listings may also include a rating area 409 where users can indicate their opinion of the channel represented in the channel listing. The rating given in the rating area 409 may be captured in the interaction history 157 as feedback for the recommendation engine 124. Additionally, the rating may also be captured in the media data 141 where it may be used in calculating a generalized rating of the channel across multiple user reviewers.

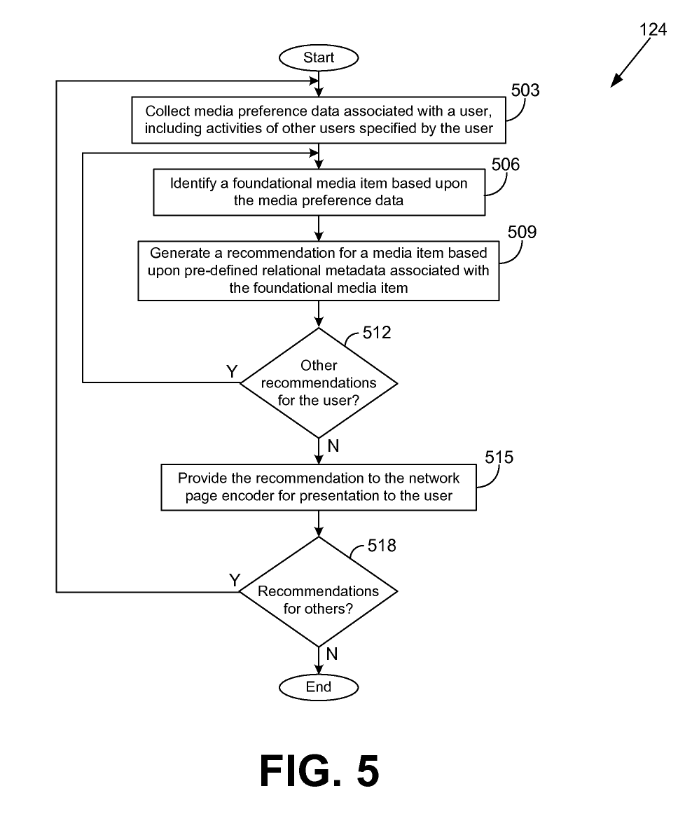

Referring next to FIG. 5, shown is a flowchart that provides one example of the operation of a portion of the recommendation engine 124 according to various embodiments. It is understood that the flowchart of FIG. 5 provides merely an example of the many different types of functional arrangements that may be employed to implement the operation of the portion of the recommendation engine 124 as described herein. As an alternative, the flowchart of FIG. 5 may be viewed as depicting an example of steps of a method implemented in the computing device 103 (FIG. 1) according to one or more embodiments.

The recommendation engine 124 may be executed in order to generate one or more recommended media items 136 based upon various media preference data previously collected. The media preference data may be that of a registered user, as well as guest users. This portion of the execution of the recommendation engine 124 may be initiated based upon changes to the media presence data, a request by the user, a periodic schedule, and/or upon occurrence of other events. To begin, in block 503, the recommendation engine 124 may obtain the various media preference data to be used to create a recommendation for a user. The various sources of media preference data for the user may include, for example, user account data 153, the media data 141, interaction history 157, storage locker 163 content history, and/or other possible sources of data for the user.

Next, in block 506, the recommendation engine 124 may identify one or more foundational media items 136 (FIG. 1) within the media preference data from which to make a recommendation. For example, a foundational media item may be a particular movie purchased by a user, an e-book frequently read by a user, a negative rating given to a particular song, and/or other possible interactions with media items 136 which may form the basis for a recommendation. Then, in block 509, the recommendation engine 124 may generate a recommendation for one or more media items 136 based upon the foundational media items 136. In some embodiments, the recommendation engine 124 may correlate the foundational media items 136 identified within the various sources of media preference data with related media items 136 defined in the relation data 147. The related media items 136 may be in a different format type than the foundational media items 136 which serves as the basis for the recommendation. In other embodiments, the recommendation engine 124 may provide a recommendation to a user for the same media item 136 included within the media preference data. Such a recommendation may be appropriate when the recommendation is based upon media preference data from media items 136 only sampled by the user, media items 136 acquired for a limited period, and/or other possible scenarios.

Continuing, in block 512, the method determines whether additional recommendations for media items 136 are to be made for the given user. If more recommendations are to be made, execution of the recommendation engine 124 returns to block 406. Alternatively, if no additional recommendations are to be made at this time for the given user, then, in block 515, the recommendation engine 124 may provide the network page encoder 127 with identifier(s) for the new recommended media item(s) to be encoded for presentation to the user.

Then, in block 518, the recommendation engine 124 determines if additional recommendations should be made for other user accounts 150 (FIG. 1). If more recommendations are to be made for other user accounts 150, execution of the recommendation engine 124 returns to block 503. Alternatively, if no further recommendations are to be made, this portion of the execution of the recommendation engine 124 ends as shown. This portion of the execution of the recommendation engine 124 may be re-activated based upon changes to the media presence data, a request by a user, a periodic schedule, and/or upon occurrence of other events.

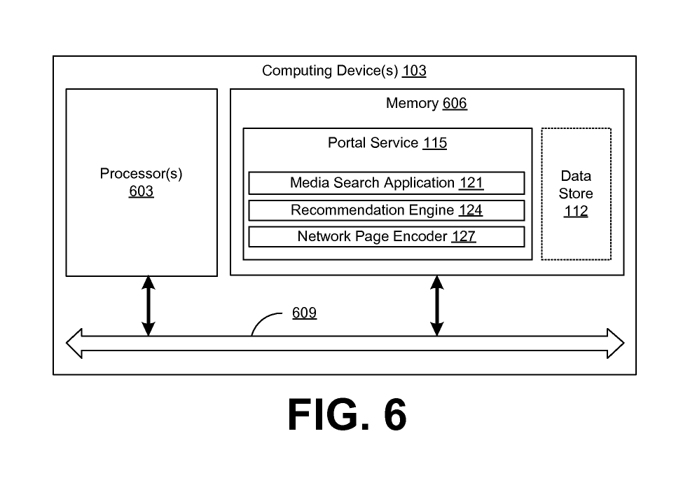

With reference to FIG. 6, shown is a schematic block diagram of the computing device 103 according to an embodiment of the present disclosure. The computing device 103 includes a processor circuit, for example, having a processor 603 and a memory 606, both of which are coupled to a local interface 609. To this end, the computing device 103 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the media search application 121, the recommendation engine 124, the network page encoder 127, and potentially other applications. Also stored in the memory 606 may be a data store 112 and other data. In addition, an operating system may be stored in the memory 606 and executable by the processor 603.

It is understood that there may be other applications that are stored in the memory 606 and are executable by the processors 603 as can be appreciated. Where any component discussed herein is implemented in the form of software, any one of a number of programming languages may be employed such as, for example, C, C++, C#, Objective C, Java, JavaScript, Perl, PHP, Visual Basic, Python, Ruby, Delphi, Flash, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and the memory 606 may represent multiple memories 606 that operate in parallel processing circuits, respectively. In such a case, the local interface 609 may be an appropriate network 109 (FIG. 1) that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the media search application 121, the recommendation engine 124, the network page encoder 127, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 5 shows the functionality and operation of an implementation of portions of the recommendation engine 124. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the media search application 121, the recommendation engine 124, and the network page encoder 127, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method comprising:
receiving, in a computing device, user characteristics for a user associated with a user account;
identifying, via a recommendation engine in the computing device, curated content from content provided by multiple distribution partners based on the user characteristics;
delivering, in the computing device, the curated content in a feed to a client device, wherein the curated content is provided within an application interface based on being signed into the user account; and
providing within the application interface of the client device a panel integrating an option for accessing the feed of the curated content and an option for accessing an additional faith-based service.

2. The method of claim 1, wherein the additional faith-based service comprises functionality for donating to a recipient charity.

3. The method of claim 2, wherein the additional faith-based service further comprises functionality for selecting the recipient charity selected from among a plurality of available charities.

4. The method of claim 2, further comprising generating a donation to the recipient charity upon a referral of a first person by the user.

5. The method of claim 4, wherein an amount of the donation is based upon a subscription fee collected from the first person.

6. The method of claim 5, wherein the donation is based further upon a referral of a second person by the first person, the amount of the donation being based upon a subscription fee collected from the second person.

7. The method of claim 1, wherein the curated content is identified based at least in part on user preferences selection of one or more preferred religious personalities.

8. The method of claim 1, wherein the curated content is identified based at least in part on user preferences selection of one or more preferred subject categories.

9. The method of claim 1, wherein the curated content is identified based at least in part on user preferences selection of one or more preferred media types.

10. The method of claim 1, wherein the curated content is identified by:
identifying a personal stage associated with the user's stage in a spirituality life cycle; and
identifying content items targeted to the user's stage.

11. A server device, comprising:
a network interface for communicating via a network accessible to the server device;
a memory for storing a portal service, wherein the portal service comprises computer-implemented instructions for performing operations relating to encoding a user interface to be transmitted from the server device, via the network, to a client device; and
a processor for executing the computer-implemented instructions of the portal service and thereby causing the portal service to:
obtain user characteristics for a user associated with a user account;
identify curated content from content provided by multiple distribution partners based on the user characteristics;
deliver the curated content in a feed to the client device, wherein the curated content is provided within the user interface based on being signed into the user account; and
providing, within the user interface of the client device, a panel integrating an option for accessing the feed of the curated content and an option for accessing an additional faith-based service.

12. The system of claim 11, wherein the multimedia channels are available when the user pays a subscription fee.

13. The system of claim 11, further comprising generating a donation to a charitable giving account of the user based upon a referral of a first person by the user.

14. The system of claim 13, wherein the referral is based upon a referral message sent by the user to the first person.

15. The system of claim 13, wherein the donation is based further upon a plurality of referrals of a plurality of people, some of the people being referred by the first person.

16. The system of claim 11, wherein the curated content present in the feed is modified based upon a rating of the curated content by the user.

17. A method comprising:
tracking a plurality of paid subscriptions for a plurality of users, each subscription providing computer access to faith-based services provided via a portal service, each subscription associated with respective donation funds associated with the respective subscription;
identifying, by the portal service, that a new subscription to the portal service is a result of a referral from a user having an existing subscription to the portal service, wherein a new subscription fee is received for the new subscription; and
based on the identifying, by the portal service, applying a portion of the new subscription fee to donation funds associated with the existing subscription, the amount added to the donation funds to be donated to one or more charities specified by the user having the existing subscription.

18. A method of claim 17, wherein the new subscription is further a result of one or more referrals by one or more ancestral users, the one or more referrals leading to the user initiating the existing subscription.
